(19) United States
(12) Patent Application Publication
(10) Pub. No.: US 2019/0304107 A1
(43) Pub. Date: Oct. 3, 2019

(54) ADDITIONAL INFORMATION DISPLAY DEVICE, ADDITIONAL INFORMATION DISPLAY METHOD, AND ADDITIONAL INFORMATION DISPLAY PROGRAM

(71) Applicant: FUJIFILM Corporation, Tokyo (JP)

(72) Inventor: Futoshi SAKURAGI, Tokyo (JP)

(73) Assignee: FUJIFILM Corporation, Tokyo (JP)

(21) Appl. No.: 16/442,680

(22) Filed: Jun. 17, 2019

Related U.S. Application Data
(63) Continuation of application No. PCT/JP2017/041143, filed on Nov. 15, 2017.

(30) Foreign Application Priority Data
Feb. 24, 2017 (JP) 2017-033132

(51) Int. Cl. G06T 7/33; G06T 7/00; G06T 5/00; G02B 27/01

(52) U.S. Cl. CPC G06T 7/33; G06T 7/0012; G02B 2027/014; G02B 27/0172; G06T 5/002

(57) ABSTRACT

An image acquisition section acquires a captured image by imaging a display on which an image is displayed, a detection section detects the display from the captured image. An additional information determination section decides additional information relating to the displayed image included in the detected display, and an alignment section aligns the displayed image and the additional information. A display controller displays the additional information on an HMD.

### CROSS REFERENCE TO RELATED APPLICATIONS

The present application is a Continuation of PCT International Application No. PCT/JP2017/041143 filed on Nov. 15, 2017, which claims priority under 35 U.S.C. § 119(a) to Japanese Patent Application No. 2017-033132 filed on Feb. 24, 2017. Each of the above applications is hereby expressly incorporated by reference, in its entirety, into the present application.

### BACKGROUND

### Technical Field

A technology of the present disclosure relates to an additional information display device, an additional information display method, and an additional information display program for displaying additional information relating to an image displayed on a display device such as a display.

### Related Art

Recently, a technique for displaying, with respect to an image acquired by an endoscope device, an angiographic device, an ultrasonic wave device, or the like, additional information such as a 3-dimensional image generated from a computed tomography (CT) image, a magnetic resonance imaging (MRI) image, or the like on the acquired image in an overlapping manner, so as to recognize a current position of an endoscope and a position of an organ or a blood vessel that is not present in the acquired image has been developed.

In order to display the additional information on the acquired image in an overlapping manner, it is necessary to embed the additional information in an endoscope device or the like, or to embed the image acquired by the endoscope device or the like in a device that generates the additional information. In a case where the additional information is embedded in the endoscope device or the like, it is necessary to improve the endoscope device or the like so as to display the additional information on the acquired image in an overlapping manner. Further, in a case where the image from the endoscope device is embedded in the device that generates the additional information, similarly, it is necessary to prepare a tool for connection with the endoscope device. Further, a medical instrument should get permission of a government office through a connection test or the like so as to be used in a clinical site. Accordingly, it is not easy to connect the endoscope device or the like to the device that generates the additional information for use in an actual diagnosis.

On the other hand, in recent years, a technique for displaying a variety of pieces of information on a head mount display (hereinafter, referred to as an HMD) has been developed. For example, JP2014-211643A and JP2012-233963A discloses a method for imaging a display on which an image is to be displayed using a camera of an HMD, detecting the display from the captured image on the basis of a shape of the display, detecting a mark displayed on the display, and projecting a screen at a position regulated on the basis of the mark detected on the HMD. Particularly, JP2012-233963A discloses a method for projecting images to be placed around the display.

However, in the methods disclosed in JP2014-211643A and JP2012-233963A, it is necessary to display the mark on the display in order to determine a position of an image to be projected. Accordingly, it is necessary to make an improvement for the display or the image to be displayed on the display. In making such an improvement, particularly, in the case of a medical instrument, it is necessary to perform an additional test or the like for getting permission of a government office, which is not easy.

### SUMMARY OF THE INVENTION

The technique of the present disclosure has been made in consideration of the above-described problems, and an object of the present disclosure is to provide a technique capable of displaying additional information together with a displayed image, without making any improvement to a device that acquires an image for superimposing additional information.

According to an aspect of the present disclosure, there is provided an additional information display device comprising: an image acquisition section that acquires a captured image acquired by imaging first display unit on which an image is displayed; detection unit for detecting the first display unit from the captured image; additional information determination unit for determining additional information relating to the displayed image included in the detected first display unit; alignment unit for aligning the detected first display unit and the additional information; and display control unit for displaying the aligned additional information on second display unit.

The “additional information” means information including an unspecified image relating to the displayed image displayed on the first display unit, and for example, in a case where the image displayed on the first display unit is an endoscopic image, a virtual endoscopic image at a position corresponding to the endoscopic image, generated from a 3-dimensional image, may be used as the additional information. Further, in a case where the image displayed on the first display unit is a contrast image of blood vessels acquired by an angiographic device, a pseudo 2-dimensional image (ray-sum image) of blood vessels of a corresponding portion generated from a 3-dimensional image may be used as the additional information. In addition, for example, vital information of a patient from whom an image is acquired or text information such as a diagnosis result, displayed on the first display unit, may also be used as the additional information.

The “aligns the detected first display unit and the additional information” means that the displayed image included in the detected first display unit, in addition to the detected first display unit, is also aligned with the additional information. Accordingly, the “aligns the detected first display unit and the additional information” includes “to align a casing such as a frame of the detected first display unit and the additional information” and “to align the displayed image included in the first display unit and the additional information”.

In the additional information display device according to this aspect of the present disclosure, the additional information determination unit may decide the additional information on the basis of a type of the detected first display unit.

In the additional information display device according to this aspect of the present disclosure, the additional information determination unit may decide the additional information on the basis of the displayed image displayed on the detected first display unit.

In the additional information display device according to this aspect of the present disclosure, the detection unit may detect the first display unit from the captured image using a shape of the first display unit.

In the additional information display device according to this aspect of the present disclosure, the alignment unit may correct the displayed image on the basis of distortion of a shape of the detected first display unit, and may align the corrected displayed image and the additional information.

In the additional information display device according to this aspect of the present disclosure, the alignment unit may correct the additional information on the basis of distortion of a shape of the detected first display unit, and may align the displayed image and the corrected additional information.

In the additional information display device according to this aspect of the present disclosure, the alignment unit may be capable of selecting whether to correct the displayed image on the basis of distortion of a shape of the detected first display unit and to align the corrected displayed image and the additional information, or to correct the additional information on the basis of the distortion of a shape of the detected first display unit and to align the displayed image and the corrected additional information.

In the additional information display device according to this aspect of the present disclosure, the additional information determination unit may decide information other than information included in the displayed image as the additional information.

In the additional information display device according to this aspect of the present disclosure, the second display unit may be a see-through type head mount display, in which an imaging section for acquiring the captured image may be attached to the head mount display.

According to another aspect of the present disclosure, there is provided an additional information display method comprising: acquiring a captured image acquired by imaging first display unit on which an image is displayed; detecting the first display unit from the captured image; determining additional information relating to the displayed image included in the detected first display unit; aligning the detected first display unit and the additional information; and displaying the aligned additional information on second display unit.

According to a still another aspect of the present disclosure, there is provided an additional information display program that causes a computer to execute the above-described additional information display method.

According to a still another aspect of the present disclosure, there is provided an additional information display device comprising: a memory that stores a command to be executed in a computer; and a processor configured to execute the stored command, in which the processor executes: an image acquisition process of acquiring a captured image acquired by imaging first display unit on which an image is displayed; a detection process of detecting the first display unit from the captured image; an additional information determination process of determining additional information relating to the displayed image included in the detected first display unit; an alignment process of aligning the detected first display unit and the additional information; and a display control process of displaying the aligned additional information on second display unit.

According to the present disclosure, first display unit is detected from a captured image acquired by imaging the first display unit on which an image is displayed, additional information relating to the displayed image included in the first display unit is determined, the detected first display unit and the additional information are aligned, and the aligned additional information is displayed on second display unit. Accordingly, it is possible to display the displayed image of the first display unit together with the additional information on the second display unit without making any improvement to the first display unit.

### BRIEF DESCRIPTION OF THE DRAWINGS

FIG. 1 is a diagram showing an outline of a diagnosis support system to which an additional information display device is applied, according to an embodiment of the present disclosure.

FIG. 2 is a diagram showing a schematic configuration of an additional information display device realized by installing an additional information display program to a computer.

FIG. 3 is a diagram showing a captured image.

FIG. 4 is a diagram showing another example of a captured image.

FIG. 5 is a diagram for illustrating alignment of additional information.

FIG. 6 is a diagram showing an image seen by an operator who wears an HMD.

FIG. 7 is a flowchart showing processes performed in the present embodiment.

FIG. 8 is a diagram showing additional information displayed on the HMD in a state where a display on which an endoscopic image is displayed is seen.

FIG. 9 is a diagram showing additional information displayed on the HMD in a state where the display on which a surgical image of the liver is displayed is seen.

FIG. 10 is a diagram for illustrating alignment of additional information.

FIG. 11 is a diagram for illustrating alignment of additional information.

FIG. 12 is a diagram for illustrating alignment of additional information.

### DETAILED DESCRIPTION

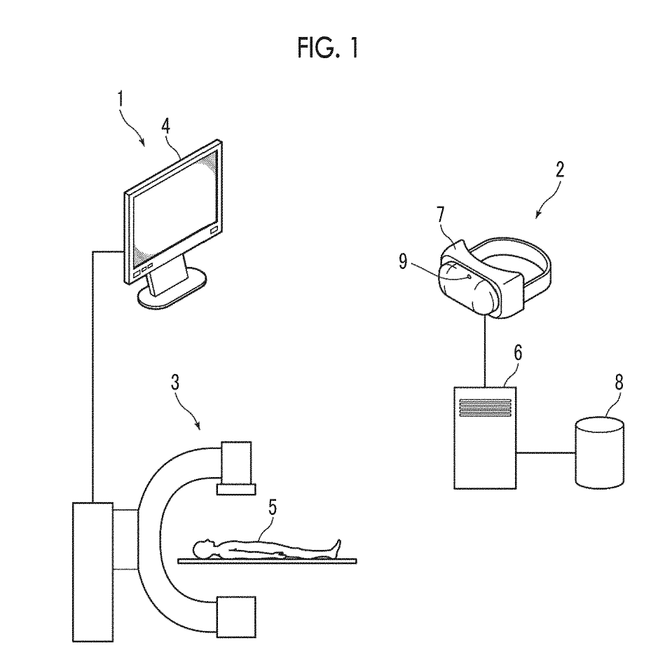

Hereinafter, embodiments of the present disclosure will be described with reference to the accompanying drawings. FIG. 1 is a diagram showing an outline of a diagnosis support system to which an additional information display device is applied, according to an embodiment of the present disclosure. As shown in FIG. 1, the diagnosis support system includes an image display system 1 and an additional information display device 2 according to the present embodiment.

The image display system 1 is a system that displays an angiographic image acquired by an angiographic device, which comprises an angiographic device 3 and a display 4. In the image display system 1, angiography of a subject 5 is performed by the angiographic device 3, and an angiographic image acquired by the angiographic device 3 is displayed on the display 4. The display 4 corresponds to first display unit.

The additional information display device 2 comprises a computer 6 and a head mount display (hereinafter, referred to as an HMD) 7. The HMD 7 corresponds to second display unit. In this embodiment, the HMD 7 is a light transmissive HMD, and an operator (for example, a doctor) of the diagnosis support system who wears the HMD 7 can see surroundings through the HMD 7 while viewing an image displayed on the HMD 7. A camera 9 that performs imaging in a sight direction of the operator of the HMD 7 is attached to the HMD 7. Further, the computer 6 is connected to an image server 8 that stores an image or the like of the subject 5 through a network. The image server 8 stores a 3-dimensional image or the like acquired by a CT apparatus, an MRI apparatus, an ultrasound apparatus, or the like, for example.

In this embodiment, in a case where the operator who wears the HMD 7 observes an image displayed on the display 4, additional information relating to the image displayed on the display 4 is displayed on the HMD 7 as described later.

The computer 6 is a computer in which an additional information display program of this embodiment is installed. The computer 6 may be a work station or a personal computer that is directly operated by a doctor who performs diagnosis, or may be a server computer connected to the work station or the personal computer through a network. The additional information display program is recorded on a recording medium such as a digital versatile disc (DVD) or a compact disk read only memory (CD-ROM) for distribution, and is installed to the computer from the recording medium. Further, the additional information display program may be stored in a storage device of the server computer connected to the network or a network storage in an accessible state from the outside, and may be downloaded and installed into a computer to be used by a doctor as necessary.

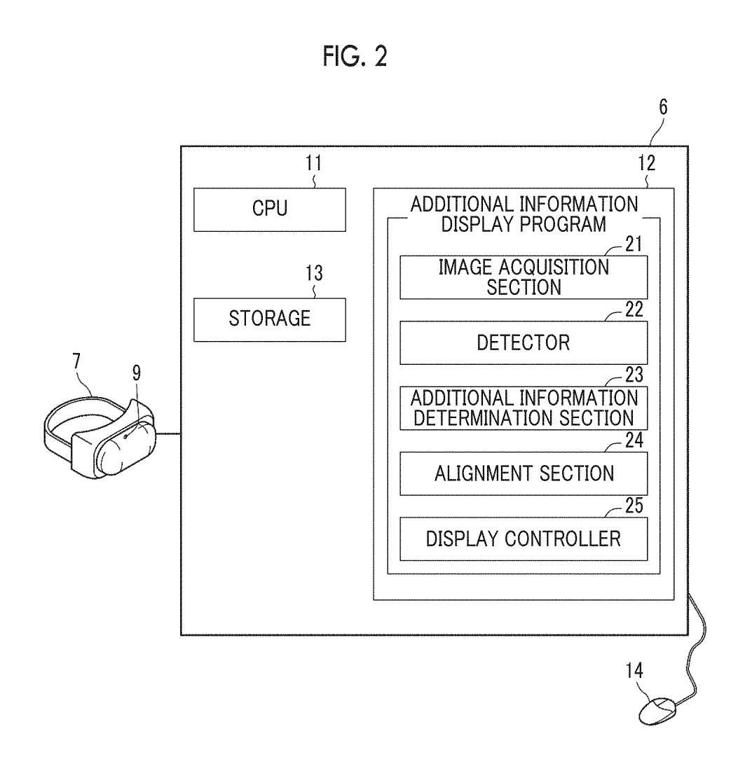

FIG. 2 is a diagram showing a schematic configuration of the additional information display device realized by installing the additional information display program to the computer. As shown in FIG. 2, the additional information display device 2 comprises a central processing unit (CPU) 11 that is a processor, a memory 12, and a storage 13, as a configuration of a standard work station. Further, the above-described HMD 7 and an input section 14 such as a mouse are connected to the additional information display device 2.

The storage 13 stores a 3-dimensional image V0 acquired from the image server 8 through the network, and a variety of pieces of information including information necessary for processes to be performed in the additional information display device 2 as described later.

Further, the memory 12 stores the additional information display program. In addition, the memory 12 also becomes a work area when the additional information display program performs processes. The additional information display program regulates an image acquisition process of acquiring a captured image acquired by imaging the display 4 on which an image is displayed by the camera 9, a detection process of detecting the display 4 from the captured image, an additional information determination process of determining additional information relating to the displayed image included in the detected display 4, an alignment process of aligning the detected display 4 and the additional information, and a display control process of displaying the aligned additional information on the HMD 7, as the process to be executed by the CPU 11.

Further, as the CPU 11 executes the processes according to the program, the computer 6 functions as an image acquisition section 21, a detection section 22, an additional information determination section 23, an alignment section 24, and a display controller 25. Further, the additional information display device 2 may be provided with a plurality of processors that respectively perform the image acquisition process, the detection process, the additional information determination process, the alignment process, and the display control process.

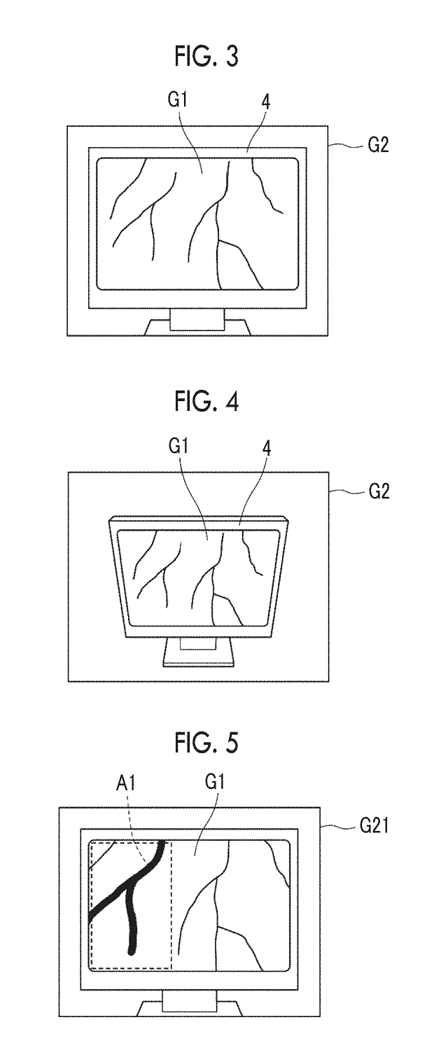

The image acquisition section 21 acquires the captured image obtained by the camera 9 attached to the HMD 7. FIG. 3 is a diagram showing an example of a captured image. As shown in FIG. 3, a captured image G2 includes the display 4 on which a display image G1 is displayed. The display image G1 is an angiographic image, and includes blood vessels contrasted by a contrast agent, for example, in the heart.

The detection section 22 detects the display 4 from the captured image G2. The detection of the display 4 may be performed by detecting a rectangular area from the captured image G2. Further, the detection may be performed by detecting a rectangular contour. As described later, in accordance with an angle at which the display 4 is seen, the shape of the display 4 included in the captured image G2 is distorted. Accordingly, the detection section 22 may detect an area surrounded by four line segments as the display 4.

The additional information determination section 23 decides additional information relating to the display image G1. In this embodiment, on the basis of the display image G1 included in the display 4 detected by the detection section 22, information different from the information included in the display image G1 is determined as the additional information. For example, the display image G1 is analyzed to determine the type of the display image G1, and additional information A1 is determined from the determination result. In this embodiment, the display image G1 is an angiographic image, in which blood vessels are contrasted. The additional information determination section 23 analyzes the display image G1 to determine that the display image G1 is the angiographic image. In a case where it is determined that the display image G1 is the angiographic image, the additional information determination section 23 decides a pseudo 2-dimensional image (ray-sum image) of blood vessels of the heart as additional information A1. The additional information determination section 23 acquires the 3-dimensional image V0 of the subject 5 from the image server 8, and generates a ray-sum image from the 3-dimensional image V0. The additional information A1 is a rectangular image in which only a blood vessel portion has a pixel value and other portions are transparent.

The alignment section 24 performs alignment of the display 4 detected from the captured image G2 and the additional information A1. In this embodiment, the alignment is performed so that the additional image A1 that is the ray-sum image is superimposed with a corresponding blood vessel of the display image G1 included in the display 4.

On the HMD 7, an imaging direction of the camera 9 and the sight direction of the operator who wears the HMD 7 deviate from each other. Accordingly, in a case where the additional information A1 is displayed on the HMD 7, before the diagnosis support system according to this embodiment is used, calibration for matching the imaging direction of the camera 9 and the sight direction of the operator is performed so that the display 4 to be seen through the HMD 7 and the additional information A1 are appropriately aligned. The calibration is performed as follows. First, a known checker board is imaged by the camera 9 in a state where the operator wears the HMD 7, and an image of the checker board is displayed on the HMD 7. Further, the operator points grid points of the checker board, and the image of the checker board displayed on the HMD 7 is magnified, is reduced, is moved in parallel, and is rotated so that the pointed positions and positions of grid points of an actual checker board match each other. Thus, conversion parameters for magnifying, reducing, moving in parallel, and rotating the images are acquired. The alignment section 24 stores the conversion parameters in the storage 13 as first parameters. By converting the image acquired by the camera 9 using the first parameters and displaying the image on the HMD 7, it is possible to cause an object seen through the HMD 7 and a position of the image of the object displayed on the HMD 7 to match each other.

The alignment section 24 corrects a distortion of the shape of the display 4 included in the captured image G2 in aligning the display 4 included in the captured image G2 and the additional information A1. In accordance with an angle at which the operator sees the display 4, as shown in FIG. 4, the shape of the display 4 included in the captured image G2 is distorted. Accordingly, the alignment section 24 converts the captured image G2 through affine transformation or the like so that the shape of the display 4 included in the captured image G2 becomes rectangular to acquire a converted captured image G21. In this case, conversion parameters are stored in the storage 13 as second parameters.

Further, the alignment section 24 performs alignment of the display 4 included in the converted captured image G21 and the additional information A1. In this embodiment, alignment of the display image G1 included in the display 4 and the additional information A1 is performed. Specifically, matching between the additional information A1 that is the ray-sum image and the display image G1 included in the converted captured image G21 is performed, and as shown in FIG. 5, the alignment is performed so that the additional information A1 is superimposed with the position of a blood vessel on the captured image G21 corresponding to the additional information A1. Through the alignment, positional coordinates at which the additional information A1 is superimposed on the converted captured image G21 are determined. The positional coordinates of the additional information A1 are coordinates of four corners of the additional information A1 on the captured image G21.

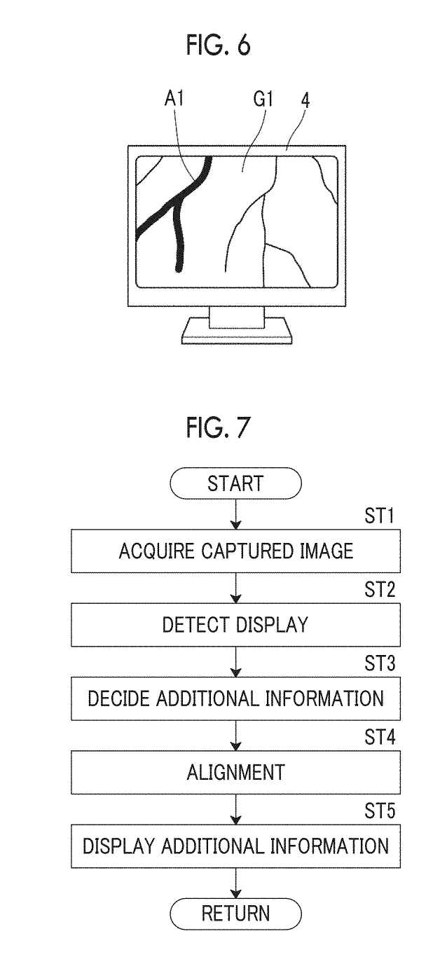

The display controller 25 displays the aligned additional information A1 on the HMD 7. Here, a position where the additional information A1 in the HMD 7 is to be displayed is converted so that the additional information A1 is aligned to the display image G1 included in the display 4 that is seen by the operator who wears the HMD 7 through the HMD 7. That is, the display controller 25 converts the additional information A1 using the above-described second parameters, converts the additional information A1 using the first parameters acquired in the calibration, and displays the result on the HMD 7. Thus, the converted additional information A1 is displayed on the display image G1 of the display 4 that is seen by the operator through the HMD 7 in an overlapping manner. FIG. 6 is a diagram showing an image seen by an operator who wears an HMD. As shown in FIG. 6, the operator who wears the HMD 7 sees the display 4 in which the display image G1 is displayed through the HMD 7, and also sees the additional information A1 aligned with the display image G1.

Next, the processes performed in this embodiment will be described. FIG. 7 is a flowchart showing the processes performed in this embodiment. It is assumed that the calibration is performed and the first parameters are stored in the storage 13. As the operator who wears the HMD 7 sees the display 4 on which an image is displayed, the camera 9 performs imaging in the sight direction of the operator, and then, the image acquisition section 21 acquires a captured image G2 (step ST1). Then, the detection section 22 detects the display 4 from the captured image G2 (step ST2), and the additional information determination section 23 decides the additional information A1 relating to the display image G1 included in the detected display 4 (step ST3). Further, the alignment section 24 aligns the detected display 4 with the additional information A1 (step ST4), and the display controller 25 displays the aligned additional information A1 on the HMD 7 (step ST5), and then, the procedure returns to step ST1. In the second and subsequent processes, the process of determining the additional information A1 using the additional information determination section 23 is omitted.

As described above, in this embodiment, a configuration in which the display 4 is detected from the captured image G2 acquired by imaging the display 4, the additional information A1 relating to the display image G1 included in the detected display 4 is determined, the detected display 4 and the additional information A1 are aligned, and the aligned additional information A1 is displayed on the HMD 7 is provided. Accordingly, even in a case where no improvement is made with respect to the display 4, it is possible to display the additional information A1 together with the display image G1 displayed on the display 4 on the HMD 7.

However, there are many cases where the type of the display 4 is changed in accordance with the type of a device to which the display 4 is connected. For example, in this embodiment, the display 4 is connected to the angiographic device 3, but a different type of display may be connected to an endoscope device. Further, there is also a case where an image is displayed on a tablet terminal. The additional information determination section 23 decides the additional information A1 on the basis of the display image G1 in the above-described embodiment, but the additional information determination section 23 may determine the type of the display 4, for example, the size of the display 4 and the shape of a frame thereof, and may determine which image is displayed on the display 4 from the determination result, and may decide the additional information A1.

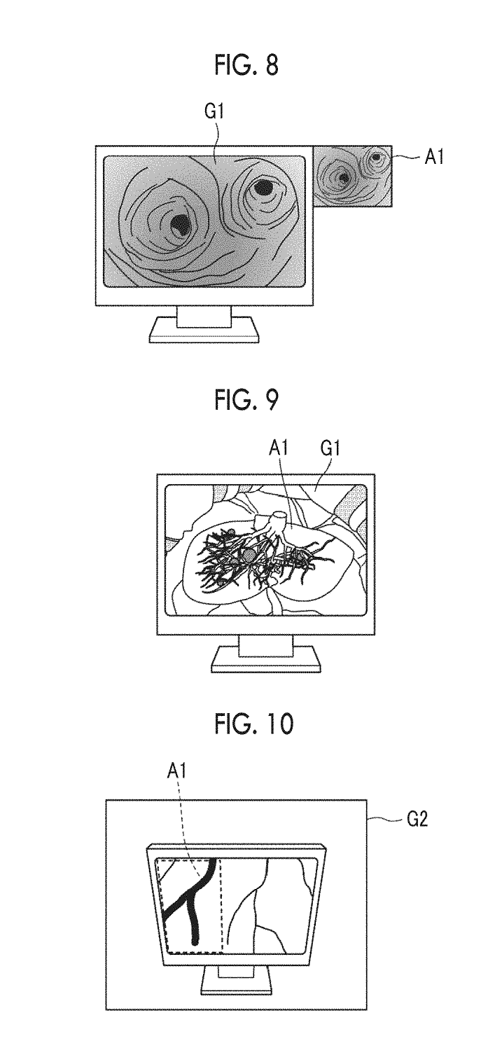

Here, in a case where the display 4 is such a type of display that displays an endoscope device, or in a case where the display image G1 is an endoscopic image, the additional information determination section 23 may decide a virtual endoscopic image generated from the 3-dimensional image V0 of the subject 5 as the additional information A1. FIG. 8 is a diagram showing additional information displayed on the HMD 7 in a state where the display 4 on which the endoscopic image is displayed is seen. In FIG. 8, the additional information A1 that is the aligned virtual endoscopic image is displayed along an outer frame of the display 4 on which the display image G1 that is the endoscopic image is displayed.

On the other hand, in a case where the image displayed on the display 4 is a surgical image of the liver, for example, a model image of the liver generated from the 3-dimensional image of the subject may be used as the additional information A1. FIG. 9 is a diagram showing the additional information A1 displayed on the HMD 7 in a state where the display 4 on which a surgical image of the liver is displayed is seen. In FIG. 9, the additional information A1 that is a model image of the liver including blood vessels and tumors of the liver is displayed on the liver included in the display image G1 displayed on the display 4 in an overlapping manner.

Further, in the above-described embodiment, the alignment section 24 converts the captured image G2 so that the shape of the display 4 becomes rectangular. However, the shape of the additional information A1 may be converted to fit the captured image G2. In this case, the alignment section 24 aligns the converted information A1 with the display 4 detected from the captured image G2. That is, matching between the converted additional information A1 and the display image G1 included in the detected display 4 is performed, and as shown in FIG. 10, the converted additional information A1 is aligned with the captured image G2 so that the converted additional information A1 is superimposed with the position of the blood vessels on the captured image G2. Through the alignment, a position at which the converted additional information A1 is superimposed with the captured image G2 is determined. Further, in this case, the display controller 25 converts the aligned additional information A1 using the first parameters acquired in the calibration, and displays the result on the HMD 7. Thus, the additional information A1 is displayed on the display image G1 of the display 4 that is seen by the operator through the HMD 7 in an overlapping manner.

Further, a configuration capable of selecting whether to convert the captured image G2 so that the shape of the display 4 becomes rectangular or to align the shape of the additional information A1 with the captured image G2 may be used. In this case, the alignment section 24 may receive a command from an input through the input section 14, and may select whether to convert the captured image G2 so that the shape of the display 4 becomes rectangular or to align the shape of the additional information A1 with the captured image G2.

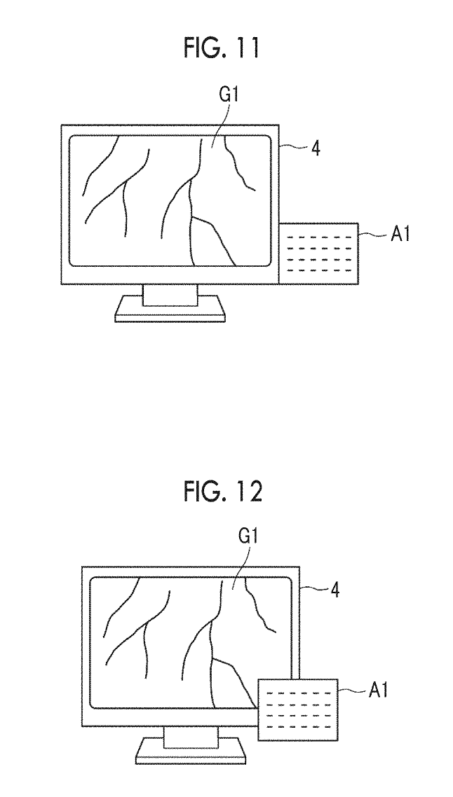

Further, in the above-described embodiment, a ray-sum image or the like is used as the additional information A1, but the additional information A1 is not limited to an image. For example, vital information on blood pressure or the like of a patient who is a subject may be used as the additional information A1. In this case, the additional information A1 is aligned with reference to the frame of the display 4 in the captured image G2. For example, as shown in FIG. 11, the additional information A1 may be aligned along the outer frame of the display 4. Further, as shown in FIG. 12, the additional information A1 may be aligned so that the center of a display area of the additional information A1 matches one apex of the display 4. Further, instead of the vital information, text information on a diagnosis result or the like, a graph indicating variation of the vital information, or the like may be used as the additional information A1.

Further, in the above-described embodiment, an example in which the HMD 7 is a see-through type HMD is shown, but an immersive type HMD may be used as the HMD 7. In this case, an image captured by the camera 9 is displayed on the HMD. Accordingly, it is not necessary to perform calibration of the captured image G2 and the additional information A1, and thus, it is possible to display the additional information A1 at higher speed.

Further, instead of the HMD, a tablet terminal may be used. In this case, the tablet terminal becomes the additional information display device according to the present embodiment. In this case, an image captured by a camera of the tablet terminal is displayed on a display of the tablet terminal, and the additional information A1 is determined and is aligned with the image displayed on the display, and then, the additional information A1 is displayed.

Hereinafter, effects of the embodiment of the present disclosure will be described.

By determining additional information on the basis of the type of detected first display unit, it is possible to display additional information suitable for an image displayed on the first display unit on second display unit.

By determining additional information on the basis of the display image displayed on the detected first display unit, it is possible to display additional information suitable for the display image on the second display unit.

By correcting a display image on the basis of distortion of the detected first display unit and aligning the corrected display image and additional information, even in a case where the first display unit is distorted due to tilting in the captured image, for example, it is possible to align the display image and additional information with high accuracy, to thereby display the additional information.

By correcting a display image on the basis of distortion of the detected first display unit and aligning the corrected display image and additional information, even in a case where the first display unit is distorted due to tilting in the captured image, for example, it is possible to display the additional information in a state of being distorted in accordance with the display image.

What is claimed is:

1. An additional information display device comprising:
image acquisition unit for acquiring a captured image acquired by imaging first display unit on which an image is displayed;
detection unit for detecting the first display unit from the captured image;
additional information determination unit for determining additional information relating to the displayed image included in the detected first display unit;
alignment unit for aligning the detected first display unit and the additional information; and
display control unit for displaying the aligned additional information on second display unit.

2. The additional information display device according to claim 1,
wherein the additional information determination unit decides the additional information on the basis of a type of the detected first display unit.

3. The additional information display device according to claim 1,
wherein the additional information determination unit decides the additional information on the basis of the displayed image displayed on the detected first display unit.

4. The additional information display device according to claim 1,
wherein the detection unit detects the first display unit from the captured image using a shape of the first display unit.

5. The additional information display device according to claim 1,
wherein the alignment unit corrects the displayed image on the basis of distortion of a shape of the detected first display unit, and aligns the corrected displayed image and the additional information.

6. The additional information display device according to claim 1,
wherein the alignment unit corrects the additional information on the basis of distortion of a shape of the detected first display unit, and aligns the displayed image and the corrected additional information.

7. The additional information display device according to claim 1,
wherein the alignment unit is capable of selecting whether to correct the displayed image on the basis of distortion of a shape of the detected first display unit and to align the corrected displayed image and the additional information, or to correct the additional information on the basis of the distortion of a shape of the detected first display unit and to align the displayed image and the corrected additional information.

8. The additional information display device according to claim 1,
wherein the additional information determination unit decides information other than information included in the displayed image as the additional information.

9. The additional information display device according to claim 1,
wherein the second display unit is a see-through type head mount display, in which an imaging section for acquiring the captured image is attached to the head mount display.

10. An additional information display method comprising:
acquiring a captured image acquired by imaging first display unit on which an image is displayed;
detecting the first display unit from the captured image;
determining additional information relating to the displayed image included in the detected first display unit;
aligning the detected first display unit and the additional information; and
displaying the aligned additional information on second display unit.

11. A non-transitory computer-readable storage medium that stores an additional information display program that causes a computer to execute:
a process of acquiring a captured image acquired by imaging first display unit on which an image is displayed;
a process of detecting the first display unit from the captured image;
a process of determining additional information relating to the displayed image included in the detected first display unit;
a process of aligning the detected first display unit and the additional information; and
a process of displaying the aligned additional information on second display
